(19) United States
(12) Patent Application Publication
(10) Pub. No.: US 2008/0023105 A1
(43) Pub. Date: Jan. 31, 2008

(54) Canter chipping heads having drive line slip joints

(76) Inventor: Brian Stroud, Salmon Arm (CA)

Correspondence Address: ANTONY C. EDWARDS, SUITE 200 - 270 HIGHWAY 33 WEST, KELOWNA, BC, V1X 1X7, US

(21) Appl. No.: 11/878,648

(22) Filed: Jul. 26, 2007

Related U.S. Application Data
(60) Provisional application No. 60/833,275, filed on Jul. 26, 2006.

(51) Int. Cl. B27B 1/00

(52) U.S. Cl. 144/4.2; 144/246.1

(57) ABSTRACT

A sawing or reducing assembly which includes at least one saw or reducing head such as a chipping head, at least one drive driving the saw or reducing head, and at least one drive line cooperating between the drive and the saw or reducing head, so as to rotatably drive the saw or reducing head. The saws or reducing heads, or at least some of them, are at least selectively transversely actuable so as to selectively translate transversely into a workpiece feed path as a workpiece is translated along the feed path into engagement with the workpiece. The drive is fixed in relation to the feed path. The drive line includes a corresponding slip joint allowing for relative movement between the drive and the saw or reducing head as the saw or reducing head is selectively translated transversely into the feed path.

### CROSS REFERENCE TO RELATED APPLICATION

This application claims priority from U.S. Provisional Patent Application No. 60/833,275 filed Jul. 26, 2006 entitled Canter Chipping Heads Having Drive Line Slip Joints.

### FIELD OF THE INVENTION

This invention relates to the field of active edgers or other sawing or reducing machines having saws or cutting heads translatable laterally into the feed-line of a workpiece, and in particular to a canter drive line driving chipping heads and having slip joints in the drive line so as to allow translation of the chipping heads independent of the drive.

### BACKGROUND OF THE INVENTION

In the prior art applicant is aware of U.S. Pat. No. 5,816,302 issued Oct. 6, 1998 to Newnes, wherein the use of chipping heads is discussed for curve sawing. FIGS. 1-4 from that patent are included as illustrating the use of conical chipping heads, although the present invention is not intended to be limited to only the use in conjunction with conical chipping heads. The point is to illustrate how in the prior art the chipping heads and their corresponding drive motors and drive shafts were all actuated, ie moved simultaneously when it was desired to translate the chipping heads, for example so as to chip the sides of a log to form a cant for curve sawing.

One example of the use of chipping heads is described in the aforementioned U.S. Pat. No. 5,816,302, where it is discussed that upstream active chipping heads may be employed to remove bulges, horns or flares on cants prior to curve sawing. Active chipping heads may also be employed immediately upstream of a sawbox, where the chipping heads are capable of moving in and out following the curve of the cant as the cant moves lineally past the chipping heads, the cant always moving in a fixed lineal path. The chipping heads are also capable of skewing left or right of the linear path of the cant so as to maintain a optimum angle of attack (normally a small degree of toe-in) at all times as the cant moves past the chipping heads. The patent discloses the use of an in-feed mechanism for positioning a cant and feeding the cant generally longitudinally into the gangsaw along a feed path, wherein the cant is oriented with its planar faces generally horizontal, and wherein the in-feed mechanism has laterally opposed laterally translatable skewable chipping heads which may be advantageously be of the disc-type laterally opposed on either side of the feed path, for opening opposed generally vertical longitudinal faces so as to form curved longitudinal profiles on laterally opposed sides of the cant according to an optimized profile solution.

In the prior art, applicant is also aware of U.S. Pat. No. 4,930,387 which issued Jun. 5, 1990 to Miettinen, in which is disclosed a circular saw having adjustable saw blades where the saw blades are disposed on a first spline arbor and blade guides are disposed on a second parallel spline arbor, wherein both arbors are connected by shifter bars disposed in the splines to common connecting plates. Each of the connecting plates have an adjusting mechanism such that each separately adjustable saw blade and its corresponding guide is attached to a separately adjustable connecting plate.

Applicant is also aware of U.S. Pat. No. 4,239,072 in which is disclosed an edger for edge trimming a board wherein two oppositely disposed cutter heads are adjustable in relation to each other in a direction transversed to the movement of the board while it is passing through the edger. It is taught that the edger can be moved for example by means of a hydraulic cylinder and a servo valve controlled by a potentiometer, it being stated that if only the cutter heads of the edger are moved the computer can control them individually. In particular it is disclosed that once the board has been measured along its entire length, the computer calculates the width of an optimum board and the position of its center line in relation to the feeding line, after which the computer adjusts the cutter heads of the edger by means of servo valves, hydraulic cylinders and potentiometers in a manner known per se.

### SUMMARY OF THE INVENTION

As will be appreciated by those skilled in the art, the speed with which for example chipping heads in the prior art may be translated in and out relative to the feed path is limited in part by the overall weight of the machine that must be moved. Thus in the present invention the translation speed of the cutting/sawing tool, of which chipping heads are one example has been increased, thereby increasing the piece rate, in the canter chipping head example, to in the order of 40 pieces processed per minute by reducing the weight to be moved, and in particular by fixing the motors and using a slip joint on the drive line.

In summary then, the present invention may be characterized in one aspect as a sawing or reducing assembly which includes at least one saw or reducing head such as a chipping head, at least one drive driving the saw or reducing head, and at least one drive line cooperating between the drive and the saw or reducing head, so as to rotatably drive the saw or reducing head, and wherein the saws or reducing heads, or at least some of them, are at least selectively transversely actuable by selectively actuable actuating means such as conventional actuators so as to selectively translate transversely into a workpiece feed path as a workpiece is translated along the feed path into engagement with the workpiece. The drive is fixed in relation to the feed path. The drive line includes a corresponding slip joint means allowing for relative movement between the drive and the saw or reducing head as the saw or reducing head is selectively translated transversely into the feed path.

In one embodiment the drive line includes fixed and translatable portions, and the corresponding slip joint means includes a splined shaft having splines aligned parallel to, so as to allow relative movement along and between, the fixed and translatable portions of the drive line. The drive may be a motor and the saws or reducing heads may include at least one chipping head. The fixed and translatable portions of the drive line may be substantially parallel, for example co-linear or co-axial.

The drive may be mounted offset from while remaining adjacent to the feed path and wherein the saw or reducing head is rigidly mounted on a corresponding selectively translatable carriage. The carriage may be mounted between the feed path and the drive.

The fixed portion may be adjacent to, so as to cooperate with, the drive, and the translatable portion may be adjacent to, so as to cooperate with, the saw or reducing head. The slip joint means may be mounted between the fixed and translatable portions.

In embodiments where the saws or reducing heads are translatable both transversely into the feed path and angularly relative to the feed path so as to angularly adjust the saws or reducing heads relative to a workpiece in the feed path, the corresponding slip joint means includes means for communicating a driving force along the drive line from the drive to the saws or reducing heads when the saws or reducing heads are angularly translated relative to the feed path. For example, such means for communicating a driving force may include at least one universal joint. In particular, the corresponding slip joint means may include a splined shaft and a pair of universal joints mounted on opposite ends of the splined shaft.

### BRIEF DESCRIPTION OF THE DRAWINGS

FIG. 1 is a prior art illustration being FIG. 1 from U.S. Pat. No. 5,816,302.

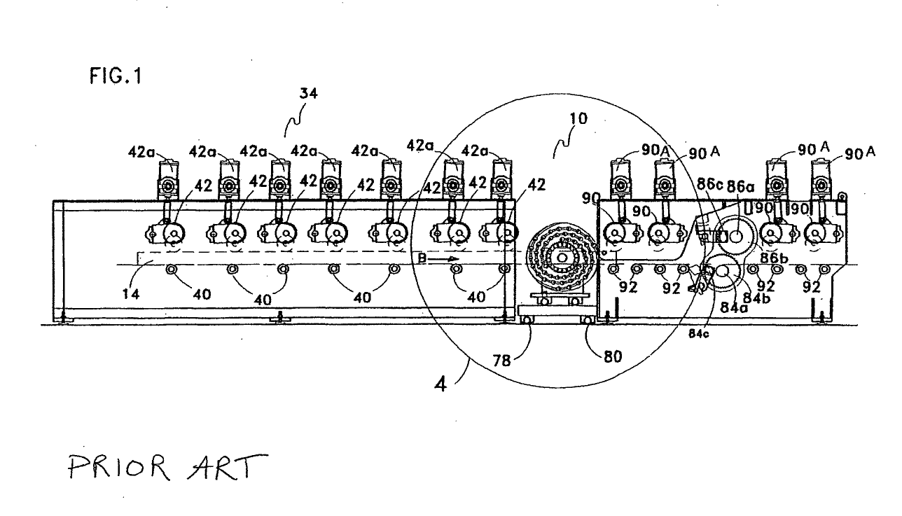

FIG. 2 is a prior art illustration being FIG. 2 from U.S. Pat. No. 5,816,302.

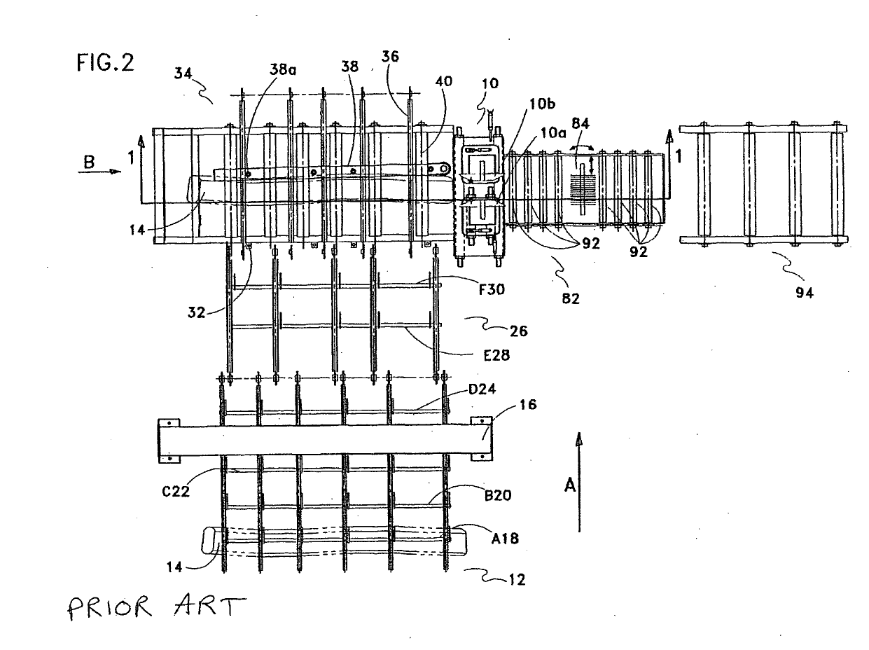

FIG. 3 is a prior art illustration being FIG. 3 from U.S. Pat. No. 5,816,302.

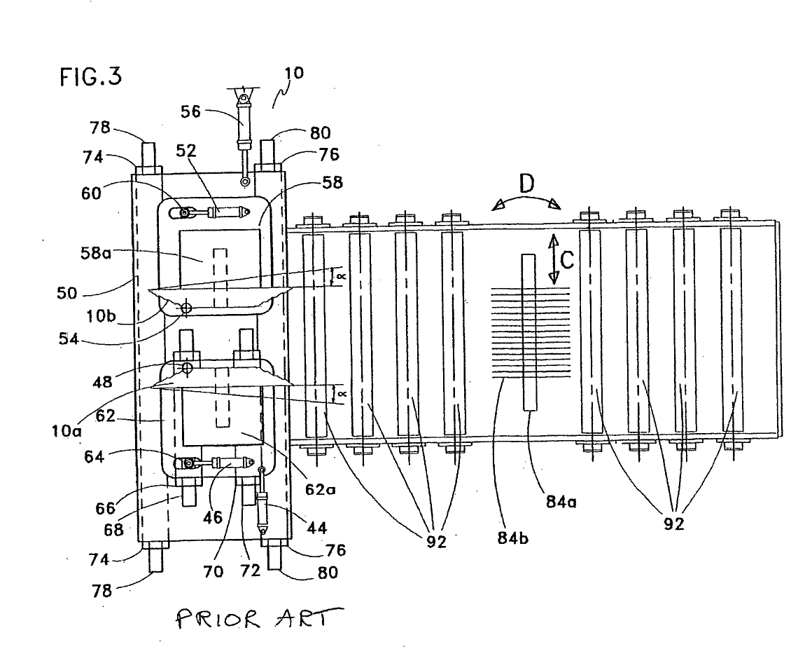

FIG. 4 is a prior art illustration being FIG. 4 from U.S. Pat. No. 5,816,302.

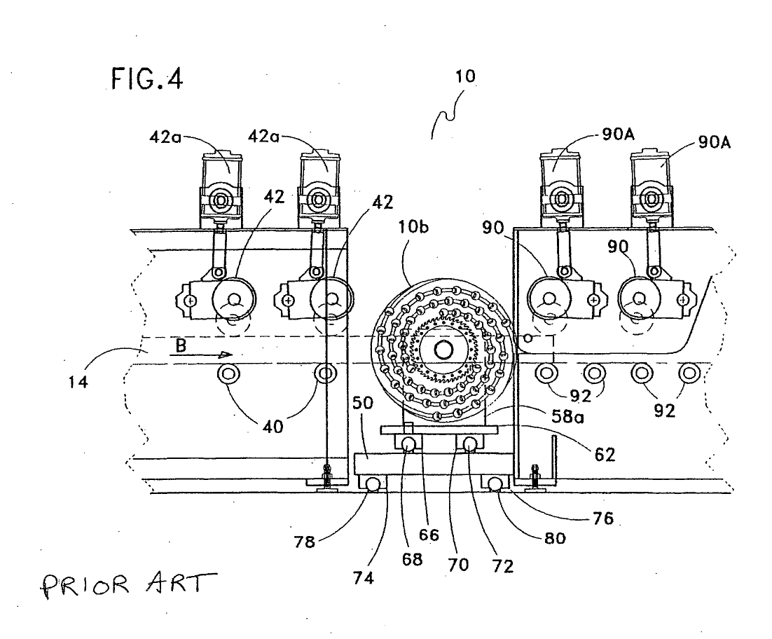

FIG. 5 is, in partially cut away side elevation view, a canter including independently translatable chipping heads and a fixed drive having a drive line therebetween incorporating a slip joint according to one aspect of the present invention.

FIG. 6 is, in partially cut away plan view, the canter of FIG. 5.

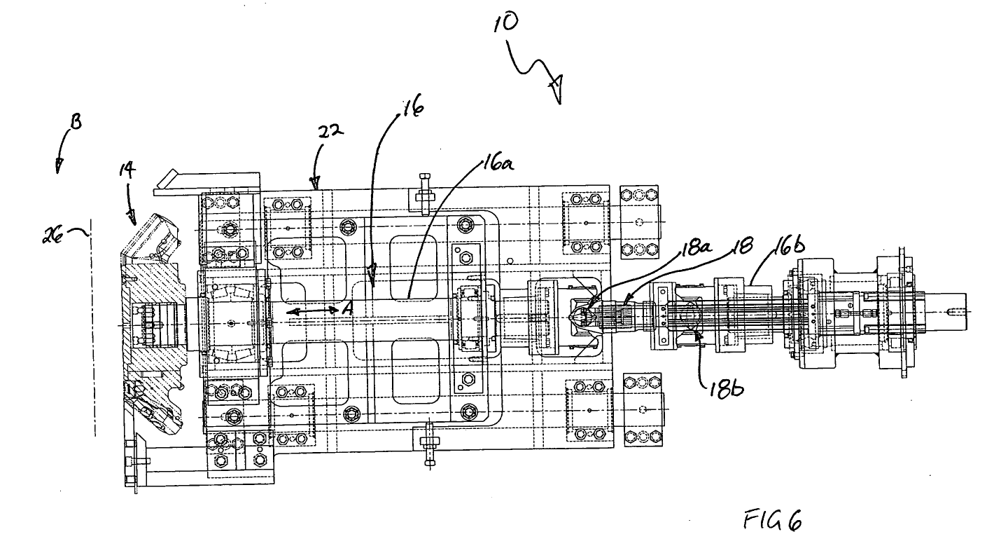

### DETAILED DESCRIPTION OF EMBODIMENTS OF THE INVENTION

To increase productivity in a sawmill wood must be cut faster and with less gap between pieces. Speed has reached a limiting threshold as we are close to the maximum cutting abilities of saws and chip heads. Therefore the only remaining avenue left to increase throughput is to reduce gaps between pieces. Gaps are required to reset the cutting tools between pieces to some preferred positions as dictated by an optimizer. The ability to move the cutting tools quickly is dependent on the force available, the mass to be moved and the friction of the sliding members. Of these the most significant is the mass.

Canter or chipping heads are driven by an electric motor through a drive system of sheaves and belts to a rotating arbor, on the other end of which is the chipping head. This whole assembly is mounted on a structural base resting on slideways and moved by a linear positioner. This unit typically may weigh eight thousand to ten thousand pounds.

In order to reduce this mass and achieve faster set times, this invention has altered this configuration. The motor, drive and supporting base are now fixed and only the chip head, its supporting arbor and bearings and a frame containing slideway bushings move. Drive to the chip head is by a truck type drive line with a slip joint. The set distance of the chip head is accommodated by the slip joint travel. The weight of this part has now been reduced to two thousand pounds which allows for faster set times.

In one embodiment employing two one hundred fifty horsepower, 1800 RPM TEFC™ motors driving a corresponding pair of chipping heads in a canter head section, the motors and drive to jack shafts are fixedly mounted, that is, they do not move with the movement of the chipping heads. The sets, that is, the movements of the chipping heads are accomplished by a slip joint in each drive line.

It has been found that, for example; approximately one and one half inches of translation of each chipping head may be accommodated by the corresponding slip joint in the drive line, which thus allows the corresponding motors to be mounted stationary. The processed piece rate is thereby improved. However, it is not intended that the present invention be limited to only 1½ inches of slip in the slip joint, or that the slip joint necessarily be of the kind found in the prior art as used for example in the rear drive of trucks to allow for movement of the suspension. The present invention is broader than that and is intended to encompass other forms of drive lines and joints which allow for relative translation of the chipping heads relative to their motors, and that the translation of each chipping may exceed one and one half inches of travel while allowing the motors to remain stationary.

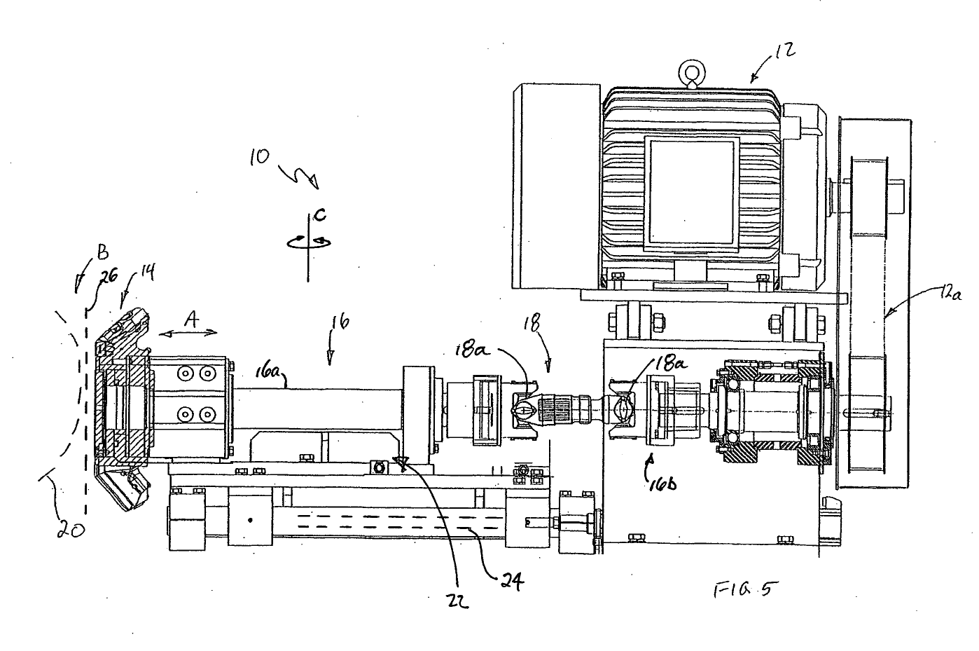

Thus as seen in the plan view of FIG. 5, the canter head section 10 includes a motor 12 driving a chipping head 14 via drive belts 12a and drive line 16. The drive line 16 includes a slip joint 18, in this case a splined slip joint mounted between a pair of universal joints 18a. Universal joints 18a and slip joint 18, collectively allow for relative movement between a translatable portion 16a of the drive line 16 and a fixed portion 16b of the drive line 16. Motor 12 may thus remain stationary while driving cutting rotation of chipping head 14 as cutting head 14 is selectively actuated in direction A laterally across the workpiece feed path B to engage, or disengage from, a workpiece 20. Cutting head 14 is carried on a carriage 22 for translation in direction A upon selective actuation by actuators 23 (shown diagrammatically in dotted outline) of a kind known in the art.

In alternative embodiments reducing heads such as chipping heads 14 may be replaced with saws 26 (also shown by way of example in dotted outline) to provide for active edging for example, in which case carriage 22 may also advantageously be articulated or otherwise translated not only transversely but also angularly about exemplary axis of rotation C.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A sawing or reducing assembly comprising:
at least one saw or reducing head,
at least one drive, and
at least one drive line cooperating between said at least one drive and said at least one saw or reducing head, so as to rotatably drive said at least one saw or reducing head,
and wherein said at least one saw or reducing head is selectively transversely actuable by selectively actuable actuating means so as to selectively translate transversely into a workpiece feed path, as a workpiece is translated along the feed path, into engagement with the workpiece, and wherein said at least one drive is fixed in relation to said feed path,
and wherein said at least one drive line includes a corresponding slip joint means allowing for relative movement between said at least one drive and said at least one saw or reducing head as said at least one saw or reducing head is selectively translated transversely into the feed path.

2. The assembly of claim 1 wherein said at least one drive line includes fixed and translatable portions, and said corresponding slip joint means includes a splined shaft having splines aligned parallel to, so as to allow relative movement along and between, said fixed and translatable portions of said at least one drive line.

3. The assembly of claim 2 wherein said drive is a motor and wherein said at least one saw or reducing head includes at least one chipping head.

4. The assembly of claim 2 wherein said fixed and translatable portions of said at least one drive line are substantially parallel.

5. The assembly of claim 4 wherein said fixed and translatable portions are co-linear.

6. The assembly of claim 2 wherein said drive is mounted offset from and adjacent to the feed path and wherein said at least one saw or reducing head is rigidly mounted on a corresponding selectively translatable carriage.

7. The assembly of claim 6 wherein said carriage is mounted between said feed path and said drive.

8. The assembly of claim 3 wherein said drive is mounted offset from and adjacent to the feed path and wherein said saw or reducing head is rigidly mounted on a selectively translatable carriage.

9. The assembly of claim 8 wherein said carriage is mounted between said feed path and said drive.

10. The assembly of claim 5 wherein said drive is mounted offset from and adjacent to the feed path and wherein said saw or reducing head is rigidly mounted on a selectively translatable carriage.

11. The assembly of claim 10 wherein said carriage is mounted between said feed path and said drive.

12. The assembly of claim 1 wherein said at least one drive line includes fixed and translatable portions,
and wherein said corresponding slip joint means is mounted therebetween, said fixed portion adjacent to so as to cooperate with said drive and said translatable portion adjacent to so as to cooperate with said at least one saw or reducing head.

13. The assembly of claim 12 wherein said fixed and translatable portions of said at least one drive line are substantially parallel.

14. The assembly of claim 13 wherein said fixed and translatable portions are co-linear.

15. The assembly of claim 12 wherein said at least one drive is mounted offset from and adjacent to the feed path and wherein said at least one saw or reducing head is rigidly mounted on a selectively translatable carriage.

16. The assembly of claim 15 wherein said carriage is mounted between said feed path and said at least one drive.

17. The assembly of claim 12 wherein said at least one saw or reducing head is translatable transversely into said feed path and is angularly translatable relative to said feed path so as to angularly adjust said at least one saw or reducing head relative to a workpiece in said feed path, and wherein said corresponding slip joint means includes means for communicating a driving force along said at least one drive line from said at least one drive to said at least one saw or reducing head when said at least one saw or reducing head is said angularly translated relative to said feed path.

18. The assembly of claim 17 wherein said means for communicating a driving force includes at least one universal joint.

19. The assembly of claim 18 wherein said corresponding slip joint means includes a splined shaft and wherein said at least one universal joint includes a pair of universal joints mounted on opposite ends of said splined shaft.

20. The assembly of claim 19 wherein said drive is a motor and wherein said at least one saw or reducing head includes at least one chipping head.
